(19) United States
(12) Patent Application Publication
(10) Pub. No.: US 2025/0222652 A1
(43) Pub. Date: Jul. 10, 2025

(54) APPARATUS AND METHODS FOR FILLING MICROCAVITIES

(71) Applicant: XTPL S.A., Wroclaw (PL)

(72) Inventors: Iwona GRADZKA-KURZAJ, Wroclaw (PL); Slawomir DROZDEK, Wroclaw (PL)

(73) Assignee: XTPL S.A., Wroclaw (PL)

(21) Appl. No.: 18/975,484

(22) Filed: Dec. 10, 2024

Related U.S. Application Data
(60) Provisional application No. 63/617,855, filed on Jan. 5, 2024.

(51) Int. Cl. B29C 64/209; B29C 64/232; B29C 64/236; B33Y 10/00; B33Y 30/00

(52) U.S. Cl. CPC B29C 64/209; B29C 64/232; B29C 64/236; B33Y 10/00; B33Y 30/00

(57) ABSTRACT

An apparatus and methods for filling microcavities are provided. For example, a method can include disposing a nozzle of a print head of an additive manufacturing system proximal to a microcavity defined in a substrate. The nozzle is disposed such that a first distance between the nozzle and a sidewall of the substrate defining the microcavity is no greater than a droplet size of an ink composition. The method can further include dispensing the ink composition from the nozzle into the microcavity. The nozzle moves at least in a horizontal path while dispensing, and the horizontal path includes a directional change of at least 15 degrees.

### CROSS-REFERENCE

This application claims priority to U.S. Provisional Patent Application No. 63/617,855, which was filed on Jan. 5, 2024. The contents of which is hereby incorporated by reference into this specification.

### BACKGROUND

Methods of additive manufacturing can involve filling microcavities defined in a substrate with an ink composition to produce electronic and optoelectronic devices such as, for example, micro-light-emitting diode (micro-LED) display devices. There are challenges with filling the microcavities.

### SUMMARY

The present disclosure provides a method of additive manufacturing. The method comprises disposing a nozzle of a print head of an additive manufacturing system proximal to a microcavity defined in a substrate, such that a first distance between the nozzle and a sidewall of the substrate defining the microcavity is no greater than a droplet size of an ink composition.

The method further comprises dispensing the ink composition from the nozzle into the microcavity. The nozzle moves at least in a horizontal path while dispensing. The horizontal path includes a directional change of at least 15 degrees.

The present disclosure also provides an apparatus for additive manufacturing. The apparatus comprises a stage, a print head, a positioning system, and a controller. The stage is configured to support a substrate that comprises a sidewall defining a microcavity. The print head comprises a nozzle. The print head is configured to dispense an ink composition through the nozzle. The positioning system is configured to move the print head relative to the substrate.

The controller is in electrical communication with the positioning system. The controller is configured to create a horizontal path for the positioning system to move the print head relative to the substrate while the print head dispenses the ink composition in the microcavity. The horizontal path includes a directional change of at least 15 degrees. The horizontal path is created based on at least one parameter selected from the group consisting of a wettability of the substrate, a viscosity of the ink composition, a geometry of the microcavity, a surface tension of the ink composition, a contact angle between the ink composition and the substrate, and a component of the ink composition.

It is understood that the present disclosure is not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a side-view schematic representation of an additive manufacturing system according to the present disclosure;

FIG. 2 is flow chart illustrating a method of filling a microcavity according to the present disclosure;

FIG. 3 is a top-view schematic representation of a nozzle of an additive manufacturing system disposed relative to a sidewall of a microcavity and a horizontal path for moving the nozzle while dispensing an ink composition into the microcavity;

FIGS. 4A-4B are side-view schematic representations of a nozzle of an additive manufacturing system disposed relative to a floor of a microcavity;

FIG. 5 is a schematic representation of a nozzle of an additive manufacturing system moving vertically away from a floor of a microcavity while dispensing an ink composition;

FIGS. 6A-6E are top-view schematic representations of horizontal paths for moving a nozzle of an additive manufacturing system while dispensing an ink composition into a microcavity;

FIG. 7 is a flow chart illustrating a method of for selecting a horizontal path for moving a nozzle of an additive manufacturing system while dispensing an ink composition into a microcavity; and

FIG. 8 is a flow chart illustrating a method of for selecting a horizontal path for moving a nozzle of an additive manufacturing system while dispensing an ink composition into a microcavity.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any references herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

Various methods of additive manufacturing involve filling microcavities defined in a substrate with an ink composition. For example, electronic and optoelectronic devices (e.g., color-conversion modules in micro-LED display devices) can be manufactured by filling microcavities defined in a silicon, polymer, quartz, and/or glass substrate with an ultraviolet (UV)-curable polymer including a fluorescent compound (e.g., semiconductor quantum dots, perovskite quantum dots) with or without scattering agents (e.g., scattering micro- or nano-particles) and UV-curable polymer formulations including primary color filters blocking selective light (e.g., cutoff under 460 nm, cut-on wavelength 500 nm). A movable nozzle can be used to successively dispense the ink composition into the microcavities. In various examples, the substrate may be placed on a movable stage that successively positions the microcavities below a static nozzle that dispenses the ink composition into the microcavities. In various examples, both the nozzle and the stage may be movable to dispense the ink composition into the microcavities.

It is often desirable to achieve uniform and precise filling of the microcavities with the ink composition. For example, microcavities that are filled with the ink composition to inconsistent heights, that are only partially covered with the ink composition, or that are overflowing with the ink composition can cause defects, such as, for example, blurriness, irregularities, or blemishes in the resulting display device. It is also often desirable to achieve rapid filling of the microcavities, for example, to optimize production efficiency. In certain examples, a certain height of the ink composition may be desired within the microcavity and the remainder of the microcavity can be empty, at least partially, or fully filled with a different material.

Various challenges can exist when attempting to achieve uniform and rapid filling of the microcavities. For example, rapidly dispensing low-viscosity ink compositions (e.g., ink compositions with a viscosity of no greater than 5,000 cP) to fill a microcavity can cause the ink composition to spill out of the cavity during filling. As another example, higher viscosity ink compositions (e.g., ink compositions with a viscosity greater than 5,000 cP) may be susceptible to “stringing,” where strands of the ink composition remain attached to the nozzle when moving from one microcavity to the next. These challenges have been attempted to be addressed by slowing the ink dispensing process, slowing the transition between filling microcavities, and/or limiting the selected ink composition based on viscosity.

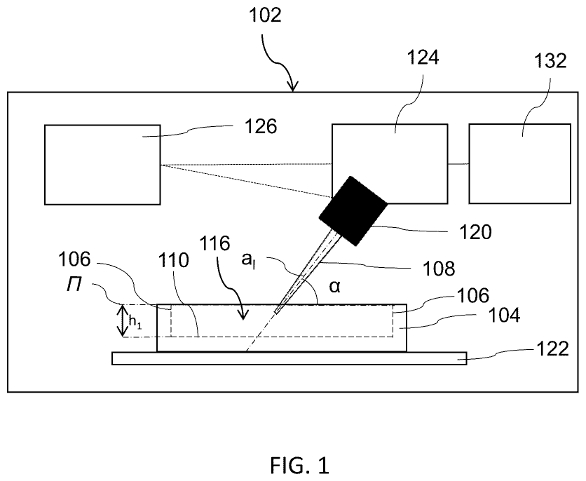

Thus, the present disclosure provides methods for additive manufacturing and additive manufacturing systems configured to perform the methods that can be used to achieve uniform, precise, and/or rapid filling of microcavities, while controlling the height of the fill. For example, the methods can comprise filling a microcavity defined in a substrate with an ink composition. Referring to FIG. 1, an example additive manufacturing system 102 according to the present disclosure is shown. The additive manufacturing system 102 can be configured to perform the methods as described herein and can comprise various hardware components in addition to a print head 120, which comprises a nozzle 108, to perform the methods as described herein. For example, the additive manufacturing system 102 can additionally comprise a stage 122 configured to support and/or move a substrate 104, a feed system (e.g., a pumping system) 132, a positioning system 124 (e.g., gantry) configured to move the print head 120 relative to the substrate 104, and a controller 126. The controller 126 can be in electrical communication with the stage 122, the positioning system 124, the feed system 132, and/or the print head 120. The feed system 132 can be in fluidic communication with the print head 120 and the nozzle 108.

As used herein, the term “controller” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field-programmable gate array (FPGA), state machine circuitry, firmware that stores instructions executed by programmable circuitry, and any combination thereof. The controller may, collectively or individually, be embodied as circuitry that forms part of a larger system, for example, an integrated circuit (IC), an application-specific IC (ASIC), a system-on-a-chip (SoC), desktop computers, laptop computers, tablet computers, servers, smart phones, etc.

Accordingly, as used herein, a “controller” can comprise electrical circuitry having at least one discrete electrical circuit, electrical circuitry having at least one IC, electrical circuitry having at least one application-specific IC, electrical circuitry forming a general-purpose computing device configured by a computer program (e.g., a general-purpose computer configured by a computer program that at least partially carries out processes and/or devices described herein or a microprocessor configured by a computer program that at least partially carries out processes and/or devices described herein), electrical circuitry forming a memory device (e.g., forms of random-access memory (RAM)), and/or electrical circuitry forming a communications device (e.g., a modem, communications switch, or optical-electrical equipment). The subject matter described herein may be implemented in an analog or digital fashion or some combination thereof.

The additive manufacturing system 102 can be similar to the fluid printing apparatus described in International Patent Application Publication No. WO 2020/157547, titled FLUID PRINTING APPARATUS, published Aug. 6, 2020, which is herein incorporated by reference in its entirety.

Referring to FIG. 1, the substrate 104 can be a printed circuit board (PCB) or other electronic hardware component, such as, for example, an electrical circuit, a thin conductive film, a display, a micro-LED, an LED, an antenna, a sensor, a micropump, a photonic IC, a quantum dot display, smart glass, or other electronic article. In some examples, the substrate 104 can comprise silicon, quartz, or glass. In various examples, the substrate 104 can be at least partially coated with silicon and have various electronic components (e.g., pads, vias, resistors, capacitors, LEDs). As illustrated in FIG. 1, the substrate 104 is substantially rectangular. In various examples, the substrate 104 can be a different shape, such as, for example, circular, triangular, pentagonal, hexagonal, or other shape.

The substrate 104 defines a microcavity 116. Specifically, the microcavity 116 is defined by sidewalls 106 of the substrate 104 and a surface 110 (e.g., floor) of the substrate 104. The top of the sidewalls 106 of the substrate 104 can define a plane, Π. A height, h₁, (e.g., vertical depth) of the microcavity 116 is defined based on a distance from the surface 110 of the substrate to the plane, H. The height, h₁, of the microcavity 116 can be in a range of 1 μm to 100 μm, such as, for example, 3 μm to 100 μm, 5 μm to 50 μm, 5 μm to 20 μm, or 5 μm to 10 μm.

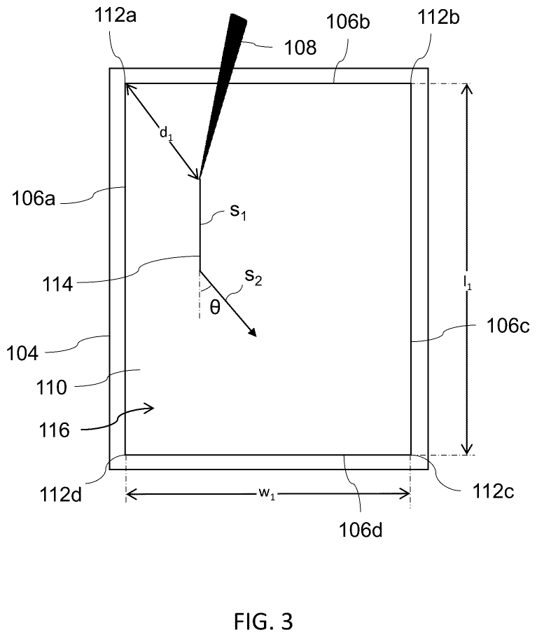

Referring to FIG. 3, as illustrated, the microcavity 116 is substantially rectangular and is defined by four sidewalls 106 (e.g., sidewall 106a, 106b, 106c, 106c) of the substrate 104. In various examples, the microcavity can be a different shape, such as, for example, circular, triangular, pentagonal, hexagonal, or other shape. As illustrated, a length, l₁, of the microcavity 116 is defined based on a distance from the sidewall 106b to the sidewall 106d, and a width, w₁, of the microcavity 116 is defined based on a distance from the sidewall 106a to the sidewall 106c. The length, l₁, and the width, w₁, can be the same or different. Furthermore, the length, l₁, may be greater than the width, w₁, or vice versa. The length, l₁, and/or the width, w₁, of the microcavity 116 can, individually, each be in a range of 10 μm to 200 μm, such as, for example, μm to 150 μm or 50 μm to 100 μm. For example, the microcavity 116 may have a length, l₁, and a width, w₁, of 50 μm×50 μm, 150 μm×40 μm, or 148 μm×48 μm. The larger of the length, l₁, and the width, w₁, of the microcavity 116 can define a horizontal span of the microcavity 116. In examples where the microcavity is a different shape, such as, for example, a circular, triangular, pentagonal, hexagonal, or other shape, the largest span between sidewalls of the microcavity can define a horizontal span of the microcavity. For example, a diameter of a circular-shaped microcavity can define a horizontal span of the microcavity.

The sidewalls 106 of the microcavity 116 can define corners of the microcavity 116. As illustrated by FIG. 3, the sidewall 106a and the sidewall 106b define a corner 112a. The sidewall 106b and the sidewall 106c define a corner 112b. The sidewall 106c and the sidewall 106d define a corner 112c. The sidewall 106d and the sidewall 106a define a corner 112d.

As illustrated, the substrate 104 includes a single microcavity 116. In various examples, the substrate 104 can include a plurality of microcavities. For example, in certain examples, the substrate 104 can comprise at least 10 microcavities, such as, for example, at least 100 microcavities, at least 500 microcavities, at least 1,000 microcavities, at least 5,000 microcavities, at least 10,000 microcavities, at least 20,000 microcavities, at least 50,000 microcavities, at least 100,000 microcavities, at least 200,000 microcavities, at least 500,000 microcavities, at least 1,000,000 microcavities, at least 1,500,000 microcavities, or at least 2,000,000 microcavities. In certain examples, the substrate 104 can comprise no greater than 3,000,000 microcavities, such as, for example, no greater than 2,000,000 microcavities, no greater than 1,500,000 microcavities, no greater than 1,000,000 microcavities, no greater than 500,000 microcavities, no greater than 200,000 microcavities, no greater than 100,000 microcavities, no greater than 50,000 microcavities, no greater than 20,000 microcavities, no greater than 10,000 microcavities, no greater than 5,000 microcavities, no greater than 2,000 microcavities, no greater than 1,000 microcavities, no greater than 500 microcavities, no greater than 100 microcavities, or no greater than 10 microcavities. In certain example, the substrate 104 can comprise a range of 10 to 3,000,000 microcavities, such as, for example a range of 1,000 to 3,000,000 microcavities, a range of 50,000 to 3,000,000 microcavities, a range of 50,000 to 2,000,000 microcavities, a range of 50,000 to 1,000,000 microcavities, a range of 10,000 to 3,000,000 microcavities, a range of 10,000 to 1,000,000 microcavities, a range of 10,000 to 500,000 microcavities, a range of 10,000 to 100,000 microcavities, a range of 1,000 to 3,000,000 microcavities, a range of 1,000 to 1,000,000 microcavities, a range of 1,000 to 500,000 microcavities, a range of 1,000 to 100,000 microcavities, a range of 1,000 to 50,000 microcavities, or a range of 1,000 to 10,000 microcavities. The substrate 104 can comprise a diameter in a range of 10 mm to 500 mm, such as, for example, 100 mm to 400 mm, or 150 mm to 350 mm. For example, the substrate 104 can comprise a diameter of 200 mm or 300 mm.

Referring again to FIG. 1, the print head 120 comprises the nozzle 108. The print head 120 is configured to dispense an ink composition through the nozzle 108. For example, the feed system 132 can be configured to apply a pressure to the ink composition in the nozzle 108 to extrude the ink composition through the nozzle 108 and dispense the ink composition into the microcavity 116. Dispensing the ink composition through the nozzle 108 can comprise applying a pressure in a range of 50 mbar to 10,000 mbar to the ink composition in the nozzle 108 to extrude the ink composition through the nozzle 108, such as, for example, a pressure in a range of 50 mbar to 10,000 mbar, 200 mbar to 5,000 mbar, 200 mbar to 3,000 mbar, 300 mbar to 2,500 mbar, 320 mbar to 2,000 mbar, or 320 mbar to 1,200 mbar. Pressures as used herein refer to gauge pressure unless stated to the contrary.

The nozzle 108 can comprise a capillary tube. The capillary tube can comprise an internal diameter in a range of 0.1 μm to 10 μm, such as, for example, 1 μm to 10 μm or 1 μm to 3 μm. The capillary tube can comprise an outer diameter in a range of 0.2 μm to 20 μm, such as, for example, 1 μm to 10 μm, 1 μm to 8 μm, or 1 μm to 5 μm.

Referring to FIG. 1, the nozzle 108 can define a longitudinal axis, a₁. An angle, α, of a longitudinal axis, a₁, relative to the plane, Π, of the substrate 104 can be a range of 30 degrees to 90 degrees, such as, for example, 40 degrees to 80 degrees, 40 degrees to 70 degrees, 45 degrees to 60 degrees, or 45 to 55 degrees. As used herein, the angle, α, is the smaller of the two angles formed by an intersection of the longitudinal axis, a₁, and the plane, Π, unless both angles are equal and then the angle, α, can be either angle formed. The angle, α, can affect the filling of the microcavity 116 by the additive manufacturing system 102 as the ink composition can wet the exterior of the nozzle 108, and thus, the angle, α, can determine an approach angle of the ink composition to the surface 110. The angle, α, can reduce the likelihood that the nozzle 108 becomes damaged while dispensing the ink composition. For example, as explained further herein, the nozzle 108 may contact the surface 110 of the substrate 104 before or while the ink composition is being dispensed. Having an angle, α, of less than 90 degrees, such as, for example, 50 degrees, can reduce the risk of damaging the nozzle 108.

The print head 120, including the nozzle 108, may move and deposit the ink composition according to machine path instructions stored in memory (e.g., non-transitory memory) of the additive manufacturing system 102 and/or of memory of a device in signal communication with the additive manufacturing system 102. For example, the machine path instructions, when executed by the controller 126 and/or a controller of a device in signal communication with the additive manufacturing system 102, can cause the controller 126 to move the print head 120 and the nozzle 108 to a desired position and deposit the ink composition according to the machine path instructions.

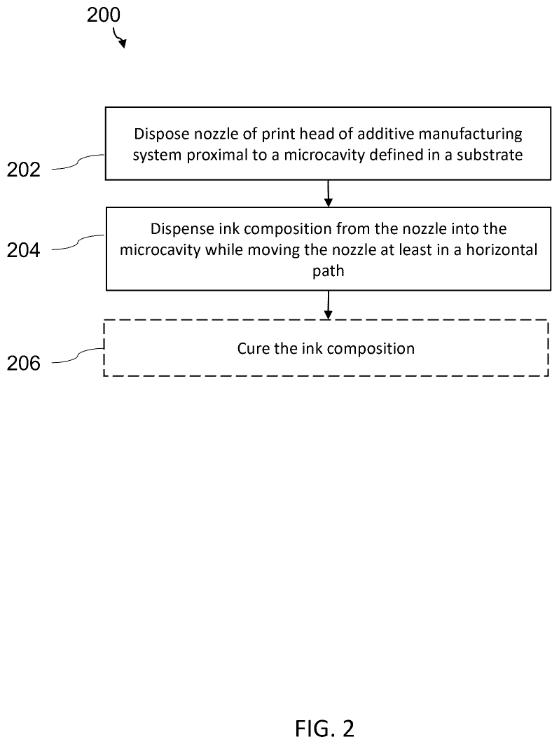

As illustrated in FIG. 2, the additive manufacturing system 102 can be configured to perform a method 200 of additive manufacturing as described herein. The method 200 comprises disposing 202 the nozzle 108 of the print head 120 of the additive manufacturing system 102 proximal to the microcavity 116.

Referring now to FIGS. 2 and 3, disposing 202 the nozzle 108 proximal to the microcavity 116 can include disposing 202 the nozzle 108 such that a distance, d₁, between the nozzle 108 and one of the sidewalls 106 of the microcavity 116 is no greater than a droplet size of the ink composition. In some examples, disposing 202 the nozzle 108 proximal to the microcavity 116 can include disposing 202 the nozzle 108 such that a distance, d₁, between the nozzle 108 and one of the sidewalls 106 of the microcavity 116 is no greater than half of the droplet size of the ink composition.

For example, the nozzle 108 may be disposed such that the distance, d₁, between the nozzle 108 the closest one of the corners 112 is no greater than a droplet size of the ink composition, such as, for example, no greater than half the droplet size of the ink composition. As illustrated by FIG. 3, the nozzle 108 is disposed closest to the corner 112a. Therefore, the distance, d₁, is defined based on the distance between the nozzle 108 and the corner 112a. Disposing 202 the nozzle 108 such that the distance, d₁, between the corner 112a and the nozzle 108 is no greater than a droplet size of the ink and/or no greater than half the droplet size of the ink composition can ensure that the ink composition covers the portion of the surface 110 between the nozzle 108 and the corner 112a when the ink composition is dispensed from the nozzle 108. The distance, d₁, can be in a range of 5 μm to 100 μm, such as, for example, 10 μm to 80 μm or 20 μm to 70 μm. In certain examples, the distance, d₁, can be no greater than 70 μm, such as, for example, no greater than 60 μm, no greater than 50 μm, no greater than 40 μm, or no greater than 35 μm.

As used herein, the “droplet size” of an ink composition may refer the diameter of a droplet of the ink composition that is formed from the nozzle of an additive manufacturing system, for example, as measured with an optical microscope (e.g., a close-up camera). The droplet forms a generally spherical shape due to surface tension of the ink composition. The droplet size of an ink composition may depend on various parameters of the additive manufacturing system that are applied to form the droplet of the ink composition. For example, the droplet size of an ink composition may depend on a diameter of the nozzle used to dispense the ink composition, a pressure applied to the ink composition by a feed system used to extrude the ink composition from the nozzle, and/or other parameters of the additive manufacturing system. Accordingly, the droplet size of an ink composition may refer to the diameter of a droplet of the ink composition that is formed while operating the additive manufacturing system according to the parameters used to dispense the ink composition to fill a microcavity.

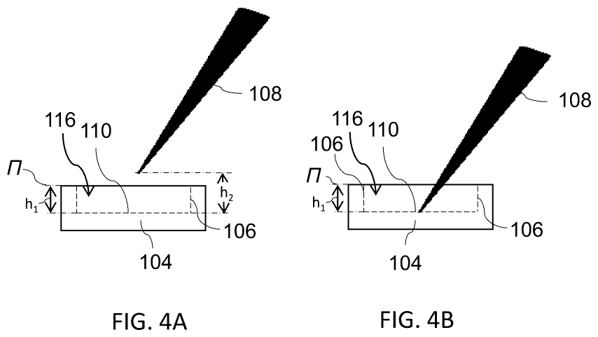

Referring to FIG. 4A, in various examples, disposing 202 the nozzle 108 proximal to the microcavity can include disposing 202 the nozzle 108 at a height, h₂, above the surface 110. The height, h₂, may be greater than, less than, or equal to the height, h₁, of the microcavity 116. For example, the nozzle 108 may be disposed above the surface 110 of the microcavity 116 at a height, h₂, in a range of 1 μm to 200 μm, such as, for example, 2 μm to 100 μm, 3 μm to 50 μm, or 5 μm to 10 μm. In certain examples, the height, h₂, may be no greater than a droplet size of the ink composition, such as, for example, no greater than half the droplet size of the ink composition.

Referring to FIG. 4B, as illustrated, in various examples, disposing 202 the nozzle 108 proximal to the microcavity 116 can include contacting the surface 110 of the substrate 104 with the nozzle 108.

Referring again to FIGS. 2 and 3, the method 200 comprises dispensing 204 the ink composition from the nozzle 108 into the microcavity 116 while moving the nozzle 108 at least in a horizontal path 114. For example, the ink composition can be initially dispensed from the nozzle 108 when the nozzle is disposed at a distance, d₁, from the corner 112a of the microcavity 116. This can cause the ink composition to contact the sidewall 106a and the sidewall 106b, thereby breaking the surface tension of the ink composition and causing the ink composition to begin filling the microcavity 116 along the sidewall 106a and the sidewall 106b. While beginning to dispense the ink composition or after beginning to dispense the ink composition (e.g., after a contact initialization period), the nozzle 108 begins moving at least along the horizontal path 114. The horizontal path 114 can be selected to cause the ink composition to uniformly fill the microcavity 116, for example, by moving the nozzle 108 such that the ink composition being dispensed grabs and flows along the sidewalls 106 and/or grabs and flows along the ink composition that was previously dispensed.

As used herein, the terms “on,” “dispensed over,” “dispensed onto,” “formed over,” “formed onto,” “deposited over,” “deposited onto,” “overlay,” “provided over,” “provided onto,” and the like, mean formed, overlaid, dispensed, deposited, or provided on but not necessarily in contact with the surface. For example, a composition “deposited onto” a substrate surface does not preclude the presence of one or more layers of the same or different composition located between the composition and the substrate.

Referring primarily to FIG. 3, in various examples, the horizontal path 114 includes segments, s, wherein a transition between each of the segments, s, is defined by a directional change of an angle, θ. For example, as illustrated, the horizontal path 114 includes a first segment, s₁, that transitions to a second segment, s₂, at a directional change defined by the angle, θ. The horizontal path 114 can include any positive integer number of segments, s (e.g., 1, 2, 3, 4, . . . n). In examples where the horizontal path 114 includes more than two segments, and therefore at least two directional changes, the angle, θ, of each of the directional changes may be the same or different. In certain examples, the at least two directional changes can individually comprise an angle, θ, of at least 15 degrees. As used herein, the angle, θ, is the smaller of the two angles formed by an intersection of two segments, unless both angles are equal, and then the angle, θ, can be either angle formed. In certain examples, the segments, s, can be substantially straight or the segments, s, can be curved.

The angle, θ, of any of the one more than one directional changes that can be included in the horizontal path 114 can be at least 15 degrees, such as, for example, at least 15 degrees, at least 20 degrees, at least 30 degrees, at least 40 degrees, at least 50 degrees, at least 60 degrees, at least 70 degrees, at least 80 degrees, at least 90 degrees, at least 105 degrees, at least 120 degrees, or at least 150 degrees. For example, the angle, θ, can be in a range of 15 degrees to 180 degrees, such as, for example, 30 degrees to 150 degrees.

The nozzle 108 can move at a defined velocity while travelling along the one or more than one segments, s, of the horizontal path 114. In certain examples, the velocity can be in a range of 10 μm/s to 2,000 μm/s, such as, for example, 10 μm/s to 1,000 μm/s, 50 μm/s to 2,000 μm/s, 50 μm/s to 800 μm/s, 200 μm/s to 800 μm/s, or 500 μm/s to 800 μm/s. In certain examples, the velocity can be at least 10 μm/s, such as, for example, at least 10 μm/s, at least 50 μm/s, at least 100 μm/s, at least 200 μm/s, at least 500 μm/s, at least 700 μm/s, at least 800 μm/s, or at least 1,000 μm/s. In certain examples, the velocity can be at no greater than 1,000 μm/s, such as, for example, no greater than 800 μm/s, no greater than 700 μm/s, no greater than 500 μm/s, no greater than 200 μm/s, no greater than 100 μm/s, no greater than 50 μm/s, or no greater than 10 μm/s.

In certain examples, while moving along any of the one or more than one segments, s, of the horizontal path 114, the nozzle 108 may accelerate to the defined velocity during an initial portion of the segment, s, maintain the defined velocity during an intermediate portion of the segment, s, and decelerate to a slower velocity or a velocity of zero during an end portion of the segment, s. The nozzle 108 may decelerate to the slower velocity or the velocity of zero during the end portion of the segment, s, to facilitate a directional change along the horizontal path 114.

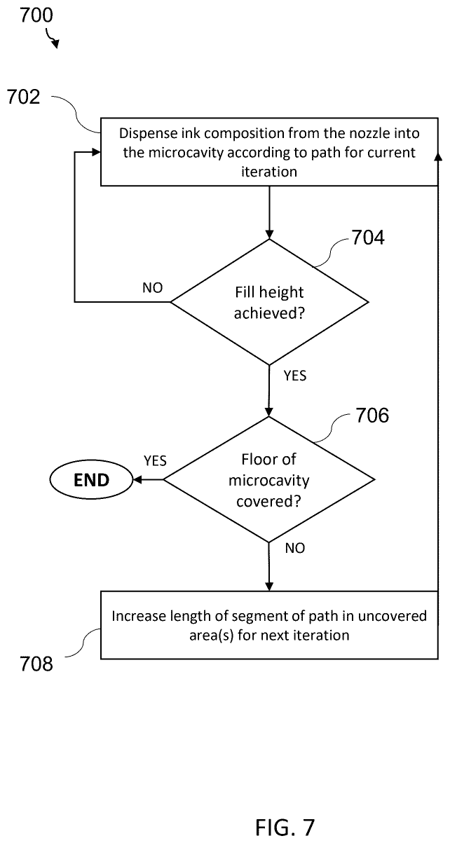

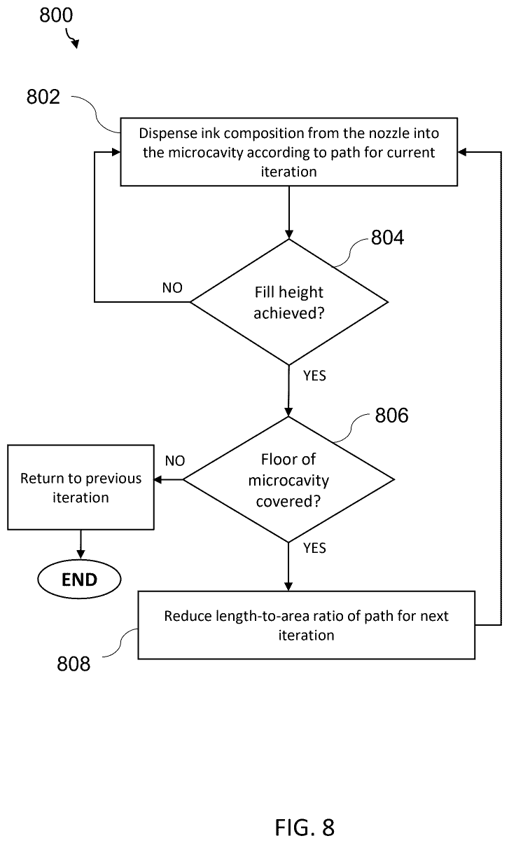

The horizontal path 114 can be configured based on various parameters, such as, for example, at least one of a wettability of the substrate, a viscosity of the ink composition, a geometry of the microcavity, a surface tension of the ink composition, a contact angle between the ink composition and the substrate, and a component of the ink composition. The horizontal path 114 may be selected according to the method 700 (FIG. 7) and/or the method 800 (FIG. 8), as described further herein. Configuring the horizontal path 114 as described herein can enable the microcavity 116 to be uniformly filled with the ink composition and/or can enable substantially all of the surface 110 to be covered with the ink composition.

The horizontal path 114 can define various shapes, such as, for example, a V-shape, a triangular shape, a Z-shape, a rectangular shape, or an S-shape.

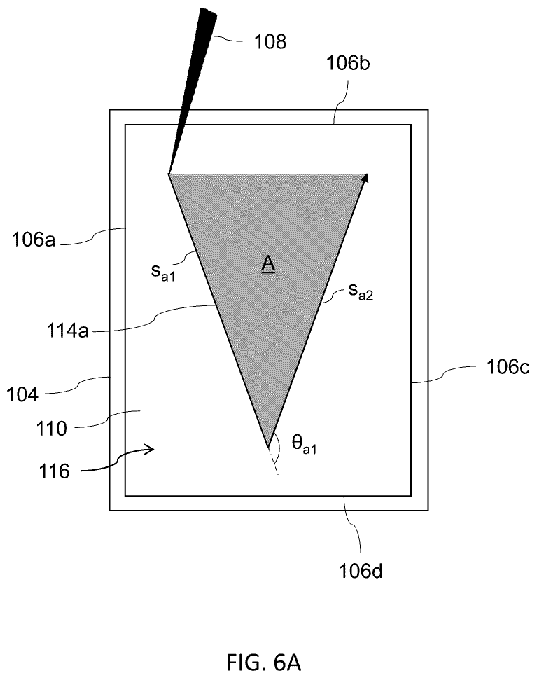

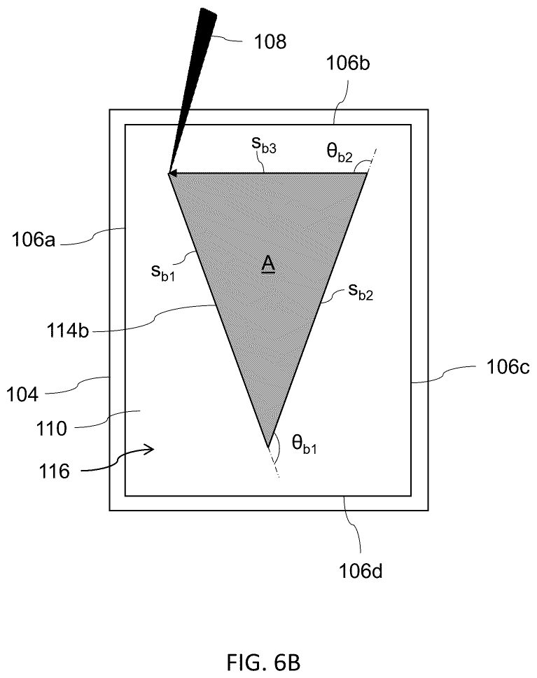

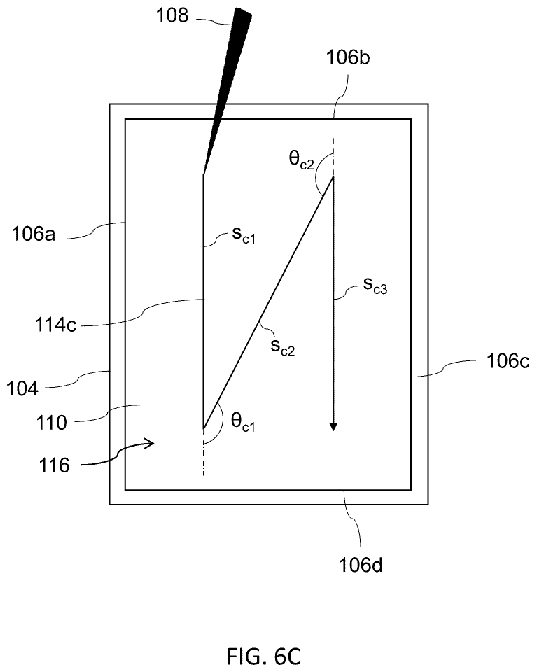

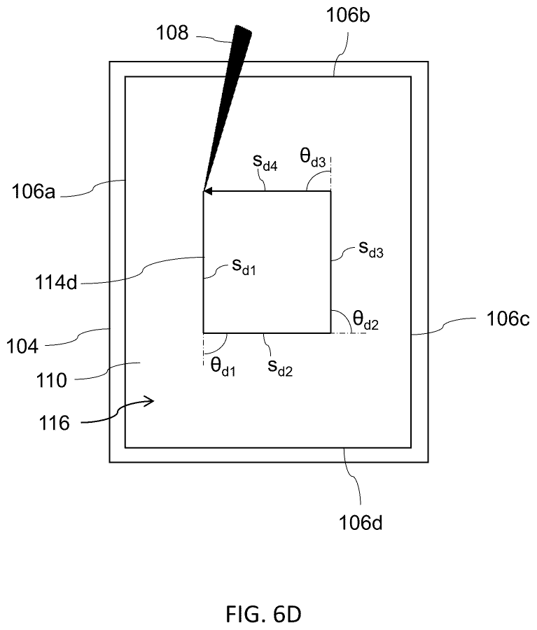

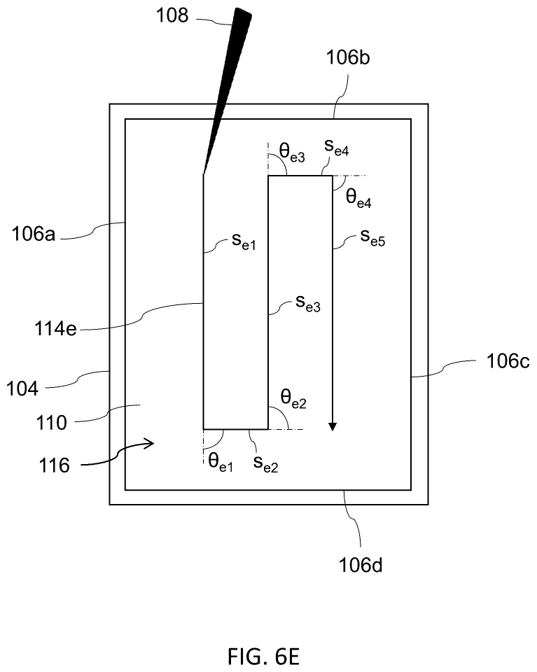

FIG. 6A illustrates an example of a horizontal path 114a that includes a V-shape. The horizontal path 114a includes a first segment, sₐ₁, that transitions to a second segment, sₐ₂, at a directional change defined by an angle, θₐ₁. The length of the first segment, sₐ₁, the length of the second segment, sₐ₂, and the size of the angle, θₐ₁, can be adjusted to achieve complete coverage of the surface 110 and uniform filling of the microcavity 116 based on any one or more of the parameters discussed above. For example, as the nozzle 108 moves along the first segment, sₐ₁, the ink composition being dispensed can flow into the microcavity 116 along the sidewall 106a and 106d. As the nozzle 108 moves along the second segment, sₐ₂, the ink composition being dispensed can flow into the microcavity 116 along the sidewall 106d, along the sidewall 106c, along the ink composition that was previously dispensed while the nozzle 108 moved along the first segment, sₐ₁, and into any remaining unfilled portions of the microcavity 116.

FIG. 6B illustrates an example of a horizontal path 114b that includes a triangular shape. The horizontal path 114b includes a first segment, s_{b1}, that transitions to a second segment, s_{b2}, at a directional change defined by an angle, θ_{b1}, that further transitions to a third segment, s_{b3}, at a directional change defined by an angle, θ_{b2}. The lengths of the segments, s_{b1}, s_{b2}, s_{b3}, and the sizes of the angles, θ_{b1}, θ_{b2}, can be adjusted to achieve complete coverage of the surface 110 and uniform filling of the microcavity 116 based on any one or more of the parameters discussed above. For example, as the nozzle 108 moves along the first segment, s_{b1}, the ink composition being dispensed can flow into the microcavity 116 along the sidewall 106a and the sidewall 106d. As the nozzle 108 moves along the second segment, s_{b2}, the ink composition being dispensed can flow into the microcavity 116 along the sidewall 106d, along the sidewall 106c, and along the ink composition that was previously dispensed while the nozzle 108 moved along the first segment, S_{b1}. As the nozzle 108 moves along the third segment, s_{b3}, the ink composition being dispensed can flow into the microcavity 116 along the sidewall 106b, along the ink composition that was previously dispensed while the nozzle 108 moved along the first segment, s_{b1}, and the second segment, s_{b2}, and into any remaining unfilled portions of the microcavity 116.

FIG. 6C illustrates an example of a horizontal path 114c that includes a Z-shape. The horizontal path 114b includes a first segment, s_{c1}, that transitions to a second segment, s_{c2}, at a directional change defined by an angle, θ_{c1}, that further transitions to a third segment, s_{c3}, at a directional change defined by an angle, θ_{c2}. The lengths of the segments, s_{c1}, s_{c2}, s_{c3}, and the sizes of angles, θ_{c1}, θ_{c2}, can be adjusted to achieve complete coverage of the surface 110 and uniform filling of the microcavity 116 based on any one or more of the parameters discussed above. For example, as the nozzle 108 moves along the first segment, s_{c1}, the ink composition being dispensed can flow into the microcavity 116 along the sidewall 106a. As the nozzle 108 moves along the second segment, s_{c2}, the ink composition being dispensed can flow into the microcavity 116 along the sidewall 106d, along the ink composition that was previously dispensed while the nozzle 108 moved along the first segment, s_{c1}, and along the sidewall 106b. As the nozzle 108 moves along the third segment, s_{c3}, the ink composition being dispensed can flow into the microcavity 116 along the sidewall 106c, along the ink composition that was previously dispensed while the nozzle 108 moved along the second segment, sₑ₂, and into any remaining unfilled portions of the microcavity 116.

FIG. 6D illustrates an example of a horizontal path 114d that includes a rectangular shape. The horizontal path 114d includes a first segment s_{d1} that transitions to a second segment, s_{d2}, at a directional change defined by an angle, θ_{d1}, that transitions to a third segment, s_{d3}, at a directional change defined by an angle, θ_{d2}, that transitions to a fourth segment, s_{d4}, at a directional change defined by an angle, θ_{d3}. In one example, horizontal path 114d can include a square shape, wherein the lengths of the segments, s_{d1}, s_{d2}, s_{d3}, s_{d4}, are the same. In another example, the lengths of the segments, s_{d1}, s_{d3} can be different from the lengths of the segments, s_{d2}, s_{d4}. The sizes of the angles, θ_{d1}, θ_{d2}, θ_{d3}, can each be 90 degrees. The lengths of the segments, s_{d1}, s_{d2}, s_{d3}, s_{d4}, can be adjusted to achieve complete coverage of the surface 110 and uniform filling of the microcavity 116 based on any one or more of the parameters discussed above. For example, as the nozzle 108 moves along the first segment, s_{d1}, the ink composition being dispensed can flow into the microcavity 116 along the sidewall 106a. As the nozzle 108 moves along the second segment, s_{d2}, the ink composition being dispensed can flow into the microcavity 116 along the sidewall 106d and along the ink composition that was previously dispensed while the nozzle 108 moved along the first segment, s_{d1}. As the nozzle 108 moves along the third segment, s_{d3}, the ink composition being dispensed can flow into the microcavity 116 along the sidewall 106c and along the ink composition that was previously dispensed while the nozzle 108 moved along the first segment, s_{d1}, and the second segment, s_{d2}. As the nozzle 108 moves along the fourth segment, s_{d4}, the ink composition being dispensed can flow into the microcavity 116 along the sidewall 106b, along the ink composition that was previously dispensed while the nozzle 108 moved along the first segment, s_{d1}, the second segment, s_{d2}, and the third segment, s_{d3}, and into any remaining unfilled portions of the microcavity 116.

FIG. 6E illustrates an example of a horizontal path 114e that includes a S-shape. The horizontal path 114e includes a first segment sₑ₁ that transitions to a second segment, sₑ₂, at a directional change defined by an angle, θₑ₁, that transitions to a third segment, sₑ₃, at a directional change defined by an angle, θₑ₂, that transitions to a fourth segment, sₑ₄, at a directional change defined by an angle, θₑ₃, that transitions to a fifth segment, sₑ₅, at a directional change defined by an angle, θₑ₄. In one example, the lengths of odd-numbered segments sₑ₁, sₑ₃, sₑ₅, may be the same as each other and the lengths of even-numbered segments sₑ₂, sₑ₄, may be the same as each other, with the lengths of the even-numbered segments being the same as or different from the lengths of the odd-numbered segments. The sizes of the angles, θₑ₁, θₑ₂, θₑ₃, θₑ₄, can each be 90 degrees. The lengths of the segments, s_{b1}, sₑ₂, sₑ₃, sₑ₄, sₑ₅, can be adjusted to achieve complete coverage of the surface 110 and uniform filling of the microcavity 116 based on any one or more of the parameters discussed above. For example, as the nozzle 108 moves along the first segment, s_{b1}, the ink composition being dispensed can flow into the microcavity 116 along the sidewall 106a. As the nozzle 108 moves along the second segment, sₑ₂, the ink composition being dispensed can flow into the microcavity 116 along the sidewall 106d. As the nozzle 108 moves along the third segment, sₑ₃, the ink composition being dispensed can flow into the microcavity 116 along the ink composition that was previously dispensed while the nozzle 108 moved along the first segment, s_{b1}. As the nozzle 108 moves along the fourth segment, sₑ₄, the ink composition being dispensed can flow into the microcavity 116 along the sidewall 106b. As the nozzle 108 moves along the fifth segment, sₑ₅, the ink composition being dispensed can flow into the microcavity 116 along the sidewall 106c and along the ink composition that was previously dispensed while the nozzle 108 moved along the third segment, sₑ₃.

As illustrated by FIG. 6E, the horizontal path 114e includes a single S-shape. In certain examples, the horizontal path 114e can include multiple concurrent and/or overlapping S-shapes. For example, the horizontal path 114e can include more than five segments (e.g., 6, 7, 8, 9, . . . n segments) that continue along a repeating S-shaped path.

Returning to FIG. 2, in various examples, dispensing 204 the ink composition from the nozzle 108 into the microcavity 116 while moving the nozzle 108 at least in a horizontal path 114 can include dispensing 204 the ink composition from the nozzle 108 while moving the nozzle 108 in a vertical path. For example, as noted with respect to FIG. 4B, the nozzle 108 may be in contact with the surface 110 of the substrate 104. Concurrent with or after the ink composition is initially dispensed from the nozzle 108, before or while moving the nozzle 108 in the horizontal path 114, the nozzle 108 can be moved vertically away from the surface 110 of the substrate 104.

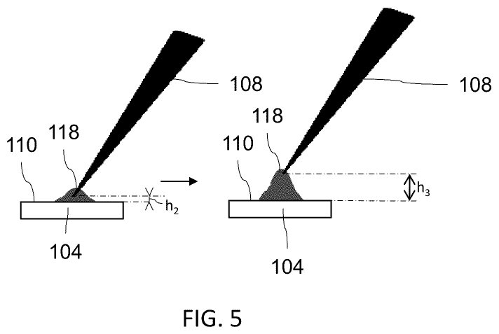

As illustrated by FIG. 5, as the ink composition 118 is being dispensed, the nozzle 108 can transition from a position with a height, h₂ (left image), to a position with a height, h₃ (right image), that is further vertically away from the surface than the height, h₂. In certain examples, the height, h₂, may be zero such that the nozzle 108 is in contact with the surface 110. In certain examples, the height, h₂, may be no greater than a droplet size of the ink composition, such as, for example, no greater than haft the droplet size of the ink composition. With the nozzle 108 in contact with the surface 110 and/or positioned at a height, h₂, that is no greater than the droplet size of the ink composition, such as, for example, a height, h₂, no greater than half the droplet size of the ink composition, the ink composition 118 can flow onto the surface 110 and remains on the surface 110 as the nozzle 108 moves vertically away from the surface 110. The nozzle 108 may move to the height, h₃, vertically above the surface 110 of the substrate 104. The height, h₃, can be in a range of 1 μm to 200 μm, such as, for example, 2 μm to 100 μm, 3 μm to 50 μm, or 5 μm to 40 μm. Contacting the nozzle 108 with the surface 110 of the substrate 104 and/or positioning the nozzle at a height, h₂, that is no greater than the droplet size of the ink composition, such as, for example, a height, h₂, no greater than half the droplet size of the ink composition when initially dispensing the ink composition 118 from the nozzle 108 can enable the ink composition 118 to contact and flow onto the surface 110 of the substrate 104. Initially dispensing the ink composition 118 when the nozzle 108 is not in contact with the surface 110 and/or when the nozzle is positioned at a height, h₂, that is greater than half a droplet size of the ink composition, such as, for example, greater than the droplet size of the ink composition, can cause the ink composition 118 to climb the outer wall of the nozzle 108 instead of contacting and flowing onto the surface 110, such as, for example, in instances wherein the ink composition 118 has a high viscosity.

Returning to FIG. 2, optionally, the method 200 can comprise curing 206 the ink composition. For example, the ink composition may be cured by applying at least one of heat and UV radiation to the ink composition. Applying heat to the ink composition can include heating the ink composition to a temperature in a range of 50° C. to 300° C., such as, for example, 150° C. to 230° C.

FIG. 7 illustrates a method 700 for selecting the horizontal path 114. The method comprises dispensing 702 the ink composition into a microcavity 116 according to the horizontal path 114 for a current iteration of the method 700. For example, the current iteration may be the first iteration and the horizontal path 114 for the first iteration may be an initial test path.

The method further comprises analyzing 704 the results of dispensing 702 the ink composition to determine if a desired fill height of the ink composition within the microcavity 116 was achieved. If the desired fill height was not achieved, then the same horizontal path 114 may be used again for dispensing 702 the ink composition into a microcavity 116 but while moving the nozzle 108 at a different (e.g., slower) velocity and/or while applying a different (e.g., higher) pressure to extrude the ink composition from the nozzle 108.

If the desired fill height was achieved, then the method 700 proceeds by analyzing 706 the results of dispensing 702 the ink composition to determine if the floor of the microcavity 116 (e.g., the surface 110) is fully covered by the ink composition. If the floor of the microcavity 116 is fully covered by the ink composition, then the method 700 may end, with the horizontal path 114 for the current iteration being the selected horizontal path 114.

If floor of the microcavity 116 is not fully covered by the ink composition, then the horizontal path 114 for the current iteration is modified by increasing 708 the length of one or more of the segments, s, based on the location of the uncovered area(s) of the floor of the microcavity 116. The modified the horizontal path 114 is used for a next iteration of dispensing 702 the ink composition. The method 700 can be repeated in an iterative fashion until the horizontal path 114 is selected.

FIG. 8 is flow chart illustrating a method 800 for selecting the horizontal path 114. The method comprises dispensing 802 the ink composition into a microcavity 116 according to the horizontal path 114 for a current iteration of the method 800. For example, the current iteration may be the first iteration and the horizontal path 114 for the first iteration may be an initial test path.

The method further comprises analyzing 804 the results of dispensing 802 the ink composition to determine if a desired fill height of the ink composition within the well was achieved. If the desired fill height was not achieved, then the same horizontal path 114 may be used again for dispensing 802 the ink composition into a microcavity 116 but while moving the nozzle 108 at a different (e.g., slower) velocity and/or while applying a different (e.g., higher) pressure to extrude the ink composition from the nozzle 108.

If the desired fill height was achieved, then the method 800 proceeds by analyzing 806 the results of dispensing 802 the ink composition to determine if the floor of the microcavity 116 (e.g., the surface 110) is fully covered by the ink composition. If the floor of the microcavity 116 is fully covered by the ink composition, then it may indicate that the floor of the microcavity 116 can be covered using a horizontal path 114 that encompasses the same area but has a shorter total length. For example, referring briefly to FIGS. 6A and 6B, as illustrated, the horizontal path 114a (FIG. 6A) and the horizontal path 114b (FIG. 6B) encompass the same area, A, of the surface 110 of the microcavity 116. In various examples, as illustrated, the total length of the horizontal path 114b is longer than the total length of the horizontal path 114a because the horizontal path 114b includes a third segment, s_{b3}, that is not included in the horizontal path 114a.

Accordingly, returning to FIG. 8, if the floor of the microcavity 116 is fully covered by the ink composition, then the horizontal path 114 for the current iteration is modified by reducing 808 the length-to-area ratio of the horizontal path 114. The modified horizontal path 114 is used for a next iteration of dispensing 802 the ink composition.

If the floor of the microcavity 116 is not fully covered by the ink composition, then it may indicate that the horizontal path 114 of the previous iteration has a desirable length-to-area ratio. Accordingly, the method 800 ends by returning to the horizontal path 114 of the previous iteration, with the horizontal path 114 for the previous iteration being the selected horizontal path 114. The method 800 can be repeated in an iterative fashion until the horizontal path 114 is selected.

The ink composition can include various components. In various examples, the ink composition can comprise a fluorescent compound. For example, the ink composition can comprise semiconducting nanoparticles (e.g., semiconductor quantum dots, perovskite quantum dots) and/or not scattering agents (e.g., microparticles, nanoparticles, ZrO₂, SiO₂, TiO₂, Zn₂O, CeO₂). The semiconducting nanoparticles can include one or more of the following structure types: core, core/shell, gradient alloyed, and/or doped, for example, lead sulfide (PbS), lead selenide (PbSe), lead telluride (PbTe), cadmium selenide (CdSe), cadmium sulfide (CdS), cadmium telluride (CdTe), HgS, HgSe, HgTe, HgSeS, HgSeTe, HgSTe, HgZnS, HgZnSe, HgZnTe, MgZnSe, MgZnS, CdZnS, CdZnSe, CdZnTe, CdHgS, CdHgSe, CdHgTe, HgZnTeS, CdZnSeS, CdZnSeTe, CdZnSTe, CdHgSeS, CdHgSeTe, CdHgSTe, HgZnSeS, HgZnSeTe, HgZnSTe, GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, SnS, SnSe, SnTe, SnSeS, SnSeTe, SnSTe, PbSeS, PbSeTe, PbSTe, SnPbS, SnPbSe, SnPbTe, SnPbSSe, SnPbSeTe, SnPbSTe, ZnGaS, ZnAlS, ZnInS, ZnGaSe, ZnAlSe, ZnInSe, ZnGaTe, ZnAlTe, ZnInTe, ZnGaO, ZnAlO, ZnInO, HgGaS, HgAlS, HgInS, HgGaSe, HgAlSe, HgInSe, HgGaTe, HgAlTe, HgInTe, MgGaS, MgAlS, MgInS, MgGaSe, MgAlSe, MgInSe, CuZnSnSe, CuZnSnS, (CdTeSeS), silver sulfide (Ag₂S), indium arsenide (InAs), indium phosphide (InP), indium zinc phosphide In(Zn)P, zinc selenide (ZnSe), zinc sulfate (ZnS), zinc telluride (ZnTe), zinc selenide telluride (ZnSeTe), zinc sulfide telluride (ZnSTe), Cu:ZnS, zinc oxide (ZnO₂), copper indium sulfide (CuInS), copper indium selenide (CuInSe₂), zinc cadmium selenide (ZnCdSe), zinc cadmium selenide sulfide (ZnCdSeS), zinc copper indium sulfide (ZnCuInS), silver indium sulfide (AgInS₂), CuIn(Ga)S₂, CuIn(Ga)Se₂, Cu₂ZnSnS₄, Cu₂ZnSnSe₄, PbMeX₃ (e.g., CsPbBr₃, CsPbI₃, CsPbCl₃, FAPbBr₃, CsPb(BrₓI₁₋ₓ)₃, FAPb(Brx-I₁₋ₓ)₃, CH₃NH₃PbI₃, CH₃NH₃PbBr₃, CH₃NH₃Pb₃₋ₓIₓ), silicone quantum dots, or carbon dots. Additionally, the structures mentioned above cover inorganic shells (e.g., ZnSe, ZnS, CdSe, CdS, or InP). The semiconducting nanoparticles can have a mean average particle size of no greater than 500 nanometers, as measured with transmission electron microscopy, such as, for example, no greater than 250 nanometers, no greater than 100 nanometers, no greater than 10 nanometers, or no greater than 7 nanometers.

In various examples, the ink composition can comprise a polymer, such as, for example, a UV-curable polymer resin or other type of photopolymer or light-activated resin. In one example, the polymer can be similar to any of the Norland Optical Adhesives manufactured by Norland Products and acrylic-based resins (e.g., tetradecyl acrylate), perfluoropolyether (PFPE)-urethane methacrylate resins, photoresist SU-8, poly(methyl methacrylate), epoxy-based resins, urethane derivatives, polyamides, acrylate-based polymers, and combinations thereof.

In various examples, the ink composition can comprise various conductive components, such as, for example, a metal, a metal alloy, a conductive carbon, or a combination thereof. For example, the ink composition can comprise metal nanoparticles, such as, for example, copper (e.g., elemental, an alloy, a compound) nanoparticles, gold (e.g., elemental, an alloy, a compound) nanoparticles, silver (e.g., elemental, an alloy, a compound) nanoparticles, or a combination thereof. The metal nanoparticles can have a mean average particle size of no greater than 500 nanometers, as measured with transmission electron microscopy, such as, for example no greater than 150 nanometers or no greater than 100 nanometers. The metal nanoparticles can comprise a metal bound to a polymer, such as, for example, polyvinylpyrrolidone.

The ink composition can comprise other components, such as, for example, a solvent (e.g., a polar protic solvent), a resin, or other compound. For example, the ink composition can comprise nanoparticles and a solvent. The ink composition can comprise at least 40% by weight nanoparticles based on the total weight of the ink composition, such as, for example, at least 50% by weight or at least 60% by weight nanoparticles all based on the total weight of the ink composition.

The ink composition can comprise a viscosity in a range of 20 cP to 10,000,000 cP, such as, for example, 20 cP to 100,000 cP, 20 cP to 40,000 cP, 50 cP to 10,000,000 cP, 50 cP to 100,000 cP, 50 cP to 4,000 cP, 100 cP to 3,000 cP, or 200 cP to 1,200 cP, for example, as measured at 25 degrees Celsius with a rheometer with a 25 mm parallel plate spindle and a shear rate in a range of 0.1 s⁻¹ to 100 s⁻¹.

### EXAMPLES

The present disclosure will be more fully understood by reference to the following examples, which provide illustrative non-limiting aspects of the present disclosure. It is understood that the present disclosure described in this specification is not necessarily limited to the examples described in this section.

Microcavities were filled using the method 200 according to the present disclosure, using a V-shaped path (e.g., the horizontal path 114a) as illustrated by FIG. 6A. For comparison, microcavities were also filled by disposing the nozzle 108 at the horizontal center of the microcavity and dispensing the ink composition from the nozzle 108 into a microcavity without moving the nozzle in a horizontal path (sometimes referred to as the “drop” method). The parameters used to fill the microcavities and corresponding observations are described below. In each example, the size of the microcavity filled was 148 μm in length, l₁, by 48 μm in width, w₁. The ink compositions dispensed are Norland Optical Adhesive compositions manufactured by Norland Products.

The parameters are defined as follows. “Print_Press_Dot” is the pressure applied to dispense the composition during the drop method. “Print_End_Dot” is the pressure applied at the end of dispensing the composition during the drop method. “Time_Print_Dot” is the amount of time the Print_Press_Dot pressure was applied. “Time_End_Dot” is the amount of time the Print_End_Dot pressure was applied. “Pressure_Working” is the pressure applied to dispense the composition according to the method 200 using a V-shaped path. “Line_Start_Delay” is the delay in time between initially contacting the nozzle with the surface of the substrate and starting to dispense the composition. “Wait_Time_Before_Lift” is the delay in time after starting to dispense the composition before lifting the nozzle from the surface of the substrate. “Printing_Vel” is the velocity of the horizontal nozzle movement along the V-shaped path. “Travel_z” is the departure height of the nozzle.

### Example 1

Norland Optical Adhesive 73, having a viscosity of 200 cp, was dispensed using the drop method according to the parameters described in Table 1. It was observed that the ink composition does not dispense without applying pressure. Nozzle contact with the surface of the substrate was required to initiate flow of the ink composition onto the substrate. A filling time of 1.5 seconds per microcavity was observed.

TABLE 1

| Parameter | Value | |
|---|---|---|
| Print_Press_Dot | 600 | mbar |
| Print_End_Dot | 100 | mbar |
| Time_Print_Dot | 300 | ms |
| Time_End_Dot | 400 | ms |
| Travel_z | 0.03 | mm |

### Example 2

Norland Optical Adhesive 73, having a viscosity of 200 cp, was dispensed while moving the nozzle in a V-shaped path according to the parameters described in Table 2. It was observed that the composition does not dispense without applying pressure. Nozzle contact with the surface of the substrate was required to initiate flow of the composition onto the substrate. A filling time of 2.0 seconds per microcavity was observed.

TABLE 2

| Parameter | Value | |
|---|---|---|
| Pressure_Working | 320 | mbar |
| Line_Start_Delay | 100 | ms |
| Wait_Time_Before_Lift | 100 | ms |
| Printing_Vel | 0.7 | mm/s |
| Travel_z | 0.03 | mm |

### Example 3

Norland Optical Adhesive 81, having a viscosity of 300 cp, was dispensed using the drop method according to the parameters described in Table 3. It was observed that the composition does not dispense without applying pressure. Nozzle contact with the surface of the substrate was required to initiate flow of the composition onto the substrate. A filling time of 1.6 seconds per microcavity was observed. Various problems filling the microcavities were observed. For example, the ink composition did not spread evenly in the microcavity, with a higher mound of ink composition forming in the center of the microcavity and areas around the edges of the microcavity left uncovered.

TABLE 3

| Parameter | Value | |
|---|---|---|
| Print_Press_Dot | 500 | mbar |
| Print_End_Dot | 100 | mbar |
| Time_Print_Dot | 300 | ms |
| Time_End_Dot | 400 | ms |
| Travel_z | 0.03 | mm |

### Example 4

Norland Optical Adhesive 81, having a viscosity of 300 cp, was dispensed while moving the nozzle in a V-shaped path according to the parameters described in Table 4. It was observed that the ink composition does not dispense without applying pressure. Nozzle contact with the surface of the substrate was required to initiate flow of the ink composition onto the substrate. A filling time of 2.0 seconds per microcavity was observed. No defects were observed.

TABLE 4

| Parameter | Value | |
|---|---|---|
| Pressure_Working | 320 | mbar |
| Line_Start_Delay | 100 | ms |
| Wait_Time_Before_Lift | 100 | ms |
| Printing_Vel | 0.7 | mm/s |
| Travel_z | 0.03 | mm |

### Example 5

Norland Optical Adhesive 65, having a viscosity of 1200 cp, was dispensed using the drop method according to the parameters described in Table 5. It was observed that the ink composition does not dispense without applying pressure. Nozzle contact with the surface of the substrate was required to initiate flow of the composition onto the substrate. A filling time of 2.0 seconds per microcavity was observed.

TABLE 5

| Parameter | Value | |
|---|---|---|
| Print_Press_Dot | 2000 | mbar |
| Print_End_Dot | 200 | mbar |
| Time_Print_Dot | 400 | ms |
| Time_End_Dot | 600 | ms |
| Travel_z | 0.03 | mm |

### Example 6

Norland Optical Adhesive 65, having a viscosity of 1200 cp, was dispensed while moving the nozzle in a V-shaped path according to the parameters described in Table 6. It was observed that the ink composition does not dispense without applying pressure. Nozzle contact with the surface of the substrate was required to initiate flow of the ink composition onto the substrate. A filling time of 2.6 seconds per microcavity was observed.

TABLE 6

| Parameter | Value | |
|---|---|---|
| Pressure_Working | 1200 | mbar |
| Line_Start_Delay | 250 | ms |
| Wait_Time_Before_Lift | 500 | ms |
| Printing_Vel | 0.7 | mm/s |
| Travel_z | 0.03 | mm |

Various aspects of the present disclosure include, but are not limited to, the aspects listed in the following numbered clauses.

Clause 1. A method of additive manufacturing, the method comprising: disposing a nozzle of a print head of an additive manufacturing system proximal to a microcavity defined in a substrate, such that a first distance between the nozzle and a sidewall of the substrate defining the microcavity is no greater than a droplet size of an ink composition; and dispensing the ink composition from the nozzle into the microcavity, wherein the nozzle moves at least in a horizontal path while dispensing and the horizontal path includes a directional change of at least 15 degrees.

Clause 2. The method of clause 1, wherein disposing the nozzle of the print head proximal to the microcavity defined in the substrate comprises contacting a surface of the substrate defining a floor of the microcavity with the nozzle of the print head, and wherein the nozzle moves vertically away from the surface of the substrate while dispensing the ink composition.

Clause 3. The method of any of clauses 1-2, wherein the ink composition is continuously dispensed during movement of the nozzle in the horizontal path.

Clause 4. The method of any of clauses 1-3, wherein the first distance is no greater than 70 μm.

Clause 5. The method of any of clauses 1-4, wherein the first distance is no greater than 50 μm.

Clause 6. The method of any of clauses 1-5, wherein the directional change is at least 80 degrees.

Clause 7. The method of any of clauses 1-6, wherein the horizontal path includes at least two directional changes of at least 15 degrees.

Clause 8. The method of any of clauses 1-5, wherein the horizontal path comprises at least one shape selected from the group consisting of a triangular shape, a rectangular shape, a V-shape, a Z-shape, and a S-shape.

Clause 9. The method of any of clauses 1-8, wherein the horizontal path is created based on at least one parameter selected from the group consisting of a wettability of the substrate, a viscosity of the ink composition, a geometry of the microcavity, a surface tension of the ink composition, a contact angle between the ink composition and the substrate, and a component of the ink composition.

Clause 10. The method of any of clauses 1-9, further comprising curing the ink composition.

Clause 11. The method of clause 10, wherein curing the ink composition comprises applying at least one stimulus selected from the group consisting of UV radiation and heat.

Clause 12. The method of any of clauses 10-11, wherein curing the ink composition comprises heating the ink composition in the microcavity to a temperature in a range of 150 degrees Celsius to 230 degrees Celsius.

Clause 13. The method of any of clauses 1-12, wherein dispensing the ink composition comprises applying a pressure in a range of 50 mbar to 10,000 mbar to the ink composition in the nozzle to extrude the ink composition through the nozzle and into the microcavity.

Clause 14. The method of any of clauses 1-13, wherein the microcavity has a vertical depth in a range of 1 μm to 100 μm and a horizontal span in a range of 10 μm to 200 μm.

Clause 15. The method of any of clauses 1-14, wherein the ink composition comprises a viscosity in a range of 50 cP to 4000 cP.

Clause 16. The method of any of clauses 1-15, wherein the nozzle comprises a capillary tube having an outer diameter equal to or lower than 8 μm.

Clause 17. An apparatus for additive manufacturing, the apparatus comprising: a stage configured to support a substrate that comprises a sidewall defining a microcavity; a print head comprising a nozzle, wherein the print head is configured to dispense an ink composition through the nozzle; a positioning system configured to move the print head relative to the substrate; and a controller in electrical communication with the positioning system, wherein the controller is configured to create a horizontal path for the positioning system to move the print head relative to the substrate while the print head dispenses the ink composition in the microcavity, wherein the horizontal path includes a directional change of at least 15 degrees, and wherein the horizontal path is created based on at least one parameter selected from the group consisting of a wettability of the substrate, a viscosity of the ink composition, a geometry of the microcavity, a surface tension of the ink composition, a contact angle between the ink composition and the substrate, and a component of the ink composition.

Clause 18. The apparatus of clause 17, wherein the controller is further configured to create a vertical path for the positioning system to lift the print head away from the substrate while the print head dispenses the ink composition in the microcavity.

Clause 19. The apparatus of any of clauses 17-18, wherein the directional change is at least 80 degrees.

Clause 20. The apparatus of any of clauses 17-19, wherein the horizontal path includes at least two directional changes of at least 15 degrees.

Clause 21. The apparatus of any of clauses 17-20, wherein the horizontal path comprises at least one shape selected from the group consisting of a triangular shape, a square shape, a V-shape, a Z-shape, and a S-shape.

Clause 22. The apparatus of any of clauses 17-21, further comprising a pressure system configured to apply a pressure in a range of 50 mbar to 10,000 mbar to the ink composition in the nozzle to extrude the ink composition through the nozzle and into the microcavity.

Clause 23. The apparatus of any of clauses 17-22, wherein the microcavity comprises a vertical depth in a range of 5 μm to 100 μm and a horizontal span in a range of 10 μm to 200 m.

Clause 24. The apparatus of any of clauses 17-23, wherein the ink composition comprises a viscosity in a range of 50 cP to 4000 cP.

Clause 25. The apparatus of any of clauses 17-24, wherein the nozzle comprises a capillary tube having an outer diameter equal to or less than 8 μm.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure material as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, and objects, as well as the discussion accompanying them, are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the appended claims, those skilled in the art will appreciate that recited operations therein may generally be performed in any order. Also, although various operational flows are presented in a sequence(s), it should be understood that the various operations may be performed in other orders than those that are illustrated, or they may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

One skilled in the art will recognize that the herein-described components, devices, operations/actions, and objects, as well as the discussion accompanying them, are used as examples for the sake of conceptual clarity and that various configuration modifications are contemplated. Consequently, as used herein, the specific examples/embodiments set forth and the accompanying discussions are intended to be representative of their more general classes. In general, use of any specific exemplar is intended to be representative of its class, and the non-inclusion of specific components, devices, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the present disclosure should be understood to be at least as broad as it is claimed and not as more narrowly defined by particular illustrative aspects provided herein.

What is claimed is:

1. A method of additive manufacturing, the method comprising:
disposing a nozzle of a print head of an additive manufacturing system proximal to a microcavity defined in a substrate, such that a first distance between the nozzle and a sidewall of the substrate defining the microcavity is no greater than a droplet size of an ink composition; and
dispensing the ink composition from the nozzle into the microcavity, wherein the nozzle moves at least in a horizontal path while dispensing and the horizontal path includes a directional change of at least 15 degrees.

2. The method of claim 1, wherein disposing the nozzle of the print head proximal to the microcavity defined in the substrate comprises contacting a surface of the substrate defining a floor of the microcavity with the nozzle of the print head, and wherein the nozzle moves vertically away from the surface of the substrate while dispensing the ink composition.

3. The method of claim 1, wherein the ink composition is continuously dispensed during movement of the nozzle in the horizontal path.

4. The method of claim 1, wherein the first distance is no greater than 70 μm.

5. The method of claim 1, wherein the first distance is no greater than 50 μm.

6. The method of claim 1, wherein the directional change is at least 80 degrees.

7. The method of claim 1, wherein the horizontal path includes at least two directional changes of at least 15 degrees.

8. The method of claim 1, wherein the horizontal path comprises at least one shape selected from the group consisting of a triangular shape, a rectangular shape, a V-shape, a Z-shape, and a S-shape.

9. The method of claim 1, wherein the horizontal path is created based on at least one parameter selected from the group consisting of a wettability of the substrate, a viscosity of the ink composition, a geometry of the microcavity, a surface tension of the ink composition, a contact angle between the ink composition and the substrate, and a component of the ink composition.

10. The method of claim 1, further comprising curing the ink composition.

11. The method of claim 10, wherein curing the ink composition comprises applying at least one stimulus selected from the group consisting of ultraviolet radiation and heat.

12. The method of claim 11, wherein curing the ink composition comprises heating the ink composition in the microcavity to a temperature in a range of 150 degrees Celsius to 230 degrees Celsius.

13. The method of claim 1, wherein dispensing the ink composition comprises applying a pressure in a range of 50 mbar to 10,000 mbar to the ink composition in the nozzle to extrude the ink composition through the nozzle and into the microcavity.

14. The method of claim 1, wherein the microcavity has a vertical depth in a range of 1 μm to 100 μm and a horizontal span in a range of 10 μm to 200 μm.

15. The method of claim 1, wherein the ink composition comprises a viscosity in a range of 50 cP to 4000 cP.

16. The method of claim 1, wherein the nozzle comprises a capillary tube having an outer diameter equal to or less than 8 μm.

17. An apparatus for additive manufacturing, the apparatus comprising:
a stage configured to support a substrate that comprises a sidewall defining a microcavity;
a print head comprising a nozzle, wherein the print head is configured to dispense an ink composition through the nozzle;
a positioning system configured to move the print head relative to the substrate; and
a controller in electrical communication with the positioning system, wherein the controller is configured to create a horizontal path for the positioning system to move the print head relative to the substrate while the print head dispenses the ink composition in the microcavity, wherein the horizontal path includes a directional change of at least 15 degrees, and wherein the horizontal path is created based on at least one parameter selected from the group consisting of a wettability of the substrate, a viscosity of the ink composition, a geometry of the microcavity, a surface tension of the ink composition, a contact angle between the ink composition and the substrate, and a component of the ink composition.

18. The apparatus of claim 17, wherein the controller is further configured to create a vertical path for the positioning system to lift the print head away from the substrate while the print head dispenses the ink composition in the microcavity.

19. The apparatus of claim 17, wherein the directional change is at least 80 degrees.

20. The apparatus of claim 17, wherein the horizontal path includes at least two directional changes of at least 15 degrees.

21. The apparatus of claim 17, wherein the horizontal path comprises at least one shape selected from the group consisting of a triangular shape, a square shape, a V-shape, a Z-shape, and a S-shape.

22. The apparatus of claim 17 further comprising a pressure system configured to apply a pressure in a range of 50 mbar to 10,000 mbar to the ink composition in the nozzle to extrude the ink composition through the nozzle and into the microcavity.

23. The apparatus of claim 17, wherein the microcavity comprises a vertical depth in a range of 5 μm to 100 μm and a horizontal span in a range of 10 μm to 200 μm.

24. The apparatus of claim 17, wherein the ink composition comprises a viscosity in a range of 50 cP to 4000 cP.

25. The apparatus of claim 17, wherein the nozzle comprises a capillary tube having an outer diameter equal to or less than 8 μm.
